(19) United States
(12) Patent Application Publication
(10) Pub. No.: US 2014/0307583 A1
(43) Pub. Date: Oct. 16, 2014

(54) CHANNEL ASSIGNMENT PROCESSES FOR HIGH DENSITY MULTI-CHANNEL MULTI-RADIO (MC-MR) WIRELESS NETWORKS

(71) Applicants: Rahul Urgaonkar, Waltham, MA (US); Subramanian Ramanathan, Westford, MA (US); Jason Redi, Belmont, MA (US); William Nii Tetteh, Cambridge, MA (US)

(72) Inventors: Rahul Urgaonkar, Waltham, MA (US); Subramanian Ramanathan, Westford, MA (US); Jason Redi, Belmont, MA (US); William Nii Tetteh, Cambridge, MA (US)

(21) Appl. No.: 14/250,815

(22) Filed: Apr. 11, 2014

Related U.S. Application Data
(60) Provisional application No. 61/811,630, filed on Apr. 12, 2013.

(51) Int. Cl. H04L 12/24

(52) U.S. Cl. CPC H04L 41/12
USPC 370/254

(57) ABSTRACT

Embodiments for providing channel assignments for high density multi-channel multi-radio (MC-MR) wireless networks are generally described herein. In some embodiments, N nodes are provided in the network. T transceiver node groups are provided that include a first number of groups of nodes, wherein the first number of groups of nodes for a first of the T transceiver node groups have the N nodes assigned consecutively with a second number of nodes per each of the groups of nodes being a function of N. The first number of group of nodes for a remaining number of the transceiver node groups comprises N nodes with transceivers arranged to provide access to any node within a predetermined number of hops. The arrangement of the second number of nodes per each of the groups of nodes in the T transceiver node groups provides an optimized throughput per node.

### CLAIM OF PRIORITY

This application claims the benefit of priority to U.S. Provisional Application Ser. No. 61/811,630, filed Apr. 12, 2013, which is incorporated herein by reference in its entirety.

### BACKGROUND

There has been a lot of research on studying optimal scaling laws for wireless ad hoc networks under different assumptions about node capabilities, availability of infrastructure support, mobility, channel models, traffic models, etc. One practical way to improve the capacity of wireless ad hoc networks is to deploy multi-channel multi-radio (MC-MR) networks. The resulting capacity gains are mainly due to the use of additional channels as compared to the single channel model. This has attracted much attention recently and several works study the problem of channel assignment, routing, and scheduling in general MC-MR networks under different constraints. Scaling laws have been developed for general MC-MR networks. However, depending on the number of interfaces per node and the number of available channels, there can be a degradation in the network capacity.

Much of this work on scaling laws has focused on general ad hoc networks where it is assumed that the nodes are randomly distributed in an area and that multi-hop routing is used for end-to-end communication. However, one scenario that has received little attention involves the situation where nodes are within the transmission range of each other. This scenario is encountered in many real-life settings. Examples include students in a lecture hall, delegates attending a conference, or a platoon of soldiers in a battlefield.

A parking lot network configuration is popular for evaluating proposed network schemes. The parking lot network derives its name from parking lots, which include several parking areas connected via a single exit path. One issue with high-density multi-channel multi-radio (MC-MR) wireless networks is throughput. Processes for providing channel assignments do not address efficiency and throughput used for today's communication.

### BRIEF DESCRIPTION OF THE DRAWINGS

FIG. 1 illustrates three channel assignments for parking lot networks;

FIG. 2 illustrates a channel assignment for a network of N=16 nodes using channels fₗ to f₈;

FIG. 3 shows the HINT-3 (Hierarchical Interleaved Channel Assignment—with 3 transceivers) assignment for a network of nodes with T=3 transceivers per node;

FIG. 4 shows channel assignments for a network of nodes with T=2 according to an embodiment;

FIG. 5 illustrates the formation of Tx-2 groups under LOG-2 according to an embodiment;

FIG. 6 illustrates the routing strategy under LOG-2 according to an embodiment;

FIG. 7 illustrates a channel assignment under RING for N=16;

FIG. 8a illustrates the plots the per node saturation throughput (in packets/sec, pps) vs. N;

FIG. 8b illustrates the plots of the total network saturation throughput vs. the number of channels used under each process according to an embodiment; and

FIG. 9 illustrates a block diagram of an example machine for providing efficient wideband inverse channelization for direct digital synthesizer based jamming techniques according to an embodiment.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass available equivalents of those claims.

According to an embodiment, optimal channel assignment, routing, and scheduling in an MC-MR parking lot network are considered to maximize the uniform per node throughput. Further, the scaling behavior of per node throughput as a function of network size is characterized. Static channel assignment algorithms are used, where a particular assignment, once assigned, is used for a reasonably long period of time, which is influenced by the practical limitations and resulting overheads associated with dynamic channel switching. In this setting, there is rich design space involving the number of available channels, number of transceivers per node and the network size. According to an embodiment, a class of algorithms are parameterized by T, the number of transceivers per node, that can achieve

$$Θ ( \frac{1}{{N}^{1 / T}} )$$

per node throughput using Θ(TN^{1-T}) channels in the parking lot model. Thus, a method in this class can achieve Θ(1) per node throughput if T=Θ(log₂ N). In view of practical constraints on T, another method that can achieve

$$Θ ( \frac{1}{{( {log}_{2} N )}^{2}} )$$

per node throughput using two transceivers per node. A fundamental relationship exists between the network size, the total number of channels used, and the achievable per node throughput under any strategy. Methods according to embodiments described herein achieve close to optimal performance at different operating points of this fundamental bound.

The parking lot model is not very interesting when considering single-channel wireless networks because in this case there is one feasible solution. To ensure connectivity, transceivers may use the same channel. This results in equipped with multiple transceivers and the network has multiple available channels, the problem of channel assignment to different transceivers to maximize per node throughput becomes non-trivial. In this case, to increase network capacity, the transceivers may be assigned to different channels. This can result in a network graph that effectively has a multi-hop topology even though nodes are within each other's transmission range and could reach each other in one hop if they were using the same channel. Further, by choosing different assignments, a variety of such effective network topologies can be formed.

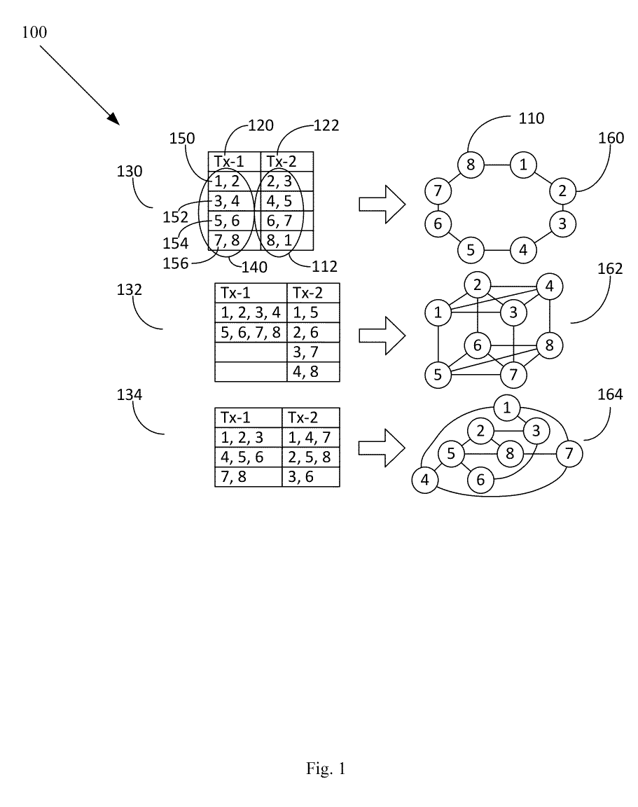

FIG. 1 illustrates three channel assignments for parking lot networks 100. Each of the networks 100 includes eight nodes 110 with two transceivers 120, 122 per node. The tables 130 132, 134 associated with each channel assignments show a list of nodes that share an orthogonal channel for the transceiver. For example, nodes 1-8 110 use first transceiver 120 arranged in 4 channels 150, 152, 154, 156. The second transceiver 122 of nodes 1-8 112 are arranged in a manner to minimize hops to any other node.

For each transceiver, Tx-1 120 and Tx-2 122, the entries in the tables 130, 132, 134 show the list of nodes that share an orthogonal channel on that transceiver. For each transceiver (Tx-1 and Tx-2), the entries in the tables show the list of nodes that share an orthogonal channel on that transceiver. The resulting effective topologies 160, 162, 164 are shown on the right. These are only three out of many possible channel assignments for network topologies.

In FIG. 1, the presence of multiple transceivers 130, 132 adds a “degree of freedom” and expands the network design space considerably. The problem of throughput maximization involves a joint optimization of the channel assignment, routing, and scheduling strategies. This leads to a tradeoff, wherein given a fixed number of transceivers per node, a channel assignment scheme uses more channels and allows for more concurrent transmissions. However, the path between any two nodes 110 tends to become longer, leading to more relay transmissions and reduced per node throughput. To keep the path lengths small, more of the nodes 110 may share a channel. However, this reduces throughput as at most one of node 110 may transmit per channel at any time because spatial reuse of frequency channels is not possible in the parking lot model.

Thus, the number of concurrent transmissions is to be maximized while keeping the path lengths small. However, this by itself is not sufficient. For example, the first transceiver 120 of nodes 110 may be assigned to the same channel and form many small groups using the remaining transceivers. With this assignment, nodes are within one hop of each other while many concurrent transmissions are possible. However, the common channel of the first transceiver becomes a bottleneck. Sufficient capacity for flows in the network is to be provided.

A network model is based on a channel model, a traffic model and a channel assignment model. The channel model may include a wireless network of N nodes, indexed 1, 2, . . . , N, where nodes are within the transmission range of each other. The network may have a total of F orthogonal frequency channels 150-156, each of bandwidth B Hz. Every node in the network may have the number, T, transceivers 120, 122≧2. Each transceiver 120, 122 may be assigned at most one channel at any time. Transceivers 120, 122 may operate in the half-duplex mode wherein the transceivers 120, 122 may transmit or receive (but not both) on a channel 150-156 at any time, and a collision model for interference allows at most one transceiver 120, 122 transmitting successfully on a channel 150-156 at any time. The link level transmission rate per channel 150-156 may be the same for channels 150-156 and is given by R bps.

For a traffic model, an N source-destination pair random unicast model may be used, where every node is the source of one unicast session destined to another node that is chosen uniformly at random. Each source may generate packets of size D bits at a rate given by λ packets/sec. The source-destination pairings are not known a priori. If the pairings were known, then the channel assignments and routing with respect to them may be optimized. This would yield higher per node throughput. However, the traffic patterns are not known a priori and/or change rapidly. Under these conditions, the traffic model is equivalent to the model where each of nodes 1-8 140 generates packets at rate λ packets/sec and each packet is equally likely to be destined to any other node. According to an embodiment, the rate, λ, that can be supported is maximized and this rate may be referred to as the uniform per node throughput.

For a channel assignment model, static channel assignment schemes are used, where a particular assignment, once assigned, is used for a reasonably long period of time. Dynamic channel assignment may be shown to outperform static schemes. Indeed, it may be shown to achieve the best possible throughput. However, factors such as switching delay, coordination overheads, and hardware constraints make dynamic channel assignment challenging to implement in practice.

Given the network model based on the above-described channel model, traffic model and channel assignment model, the uniform per node throughput may be maximized. Since the channel assignments under such a policy may effectively create a multi-hop topology, the overall policy includes the channel assignment, routing and transmission scheduling processes. For any given tuple, (N, T, F), this can be formulated as an optimization problem that searches over possible channel assignment, routing, and scheduling options and yields the maximum throughput. However, given the enormous search space, this approach quickly becomes intractable and does not yield useful insights.

Instead, a scaling analysis approach may be used, where the scaling behavior of the achievable throughput is characterized as a function of the network size N. This approach, while being tractable, provides insights into the optimal network design and helps derive scaling laws. In analyzing the scaling behavior of the throughput, the number of available channels, F, may scale with the number of nodes, N, according to a fixed function. For example, F(N) may be \sqrt{N}. This approach significantly simplifies the problem and allows the development of processes with achievable throughput that may be computed exactly in closed form. For simplicity, transmission rates are normalized and idealized so that 1 packet may be transmitted per channel use.

An embodiment described herein includes HINT-T (Hierarchical Interleaved Channel Assignment—with T transceivers), which is a class of channel assignment strategies that may achieve

$$Θ ( \frac{1}{{N}^{1 / T}} )$$

per node throughput using

$$F = Θ ( {N}^{\frac{T - 1}{T}} )$$

channels and T transceivers per node. The process is based on forming

$${N}^{\frac{T - 1}{T}}$$

groups, each of size N^{1/N}, for every transceiver index. Then, transceivers 120, 122 are assigned to these groups in such a way that each of nodes 1-8 140 may reach every other node in at most T hops. For simplicity of presentation, N^{1/T} will be an integer. However, embodiments described herein may be modified to be applicable when N^{1/T} is not an integer. However, for brevity, this extension is not described herein.

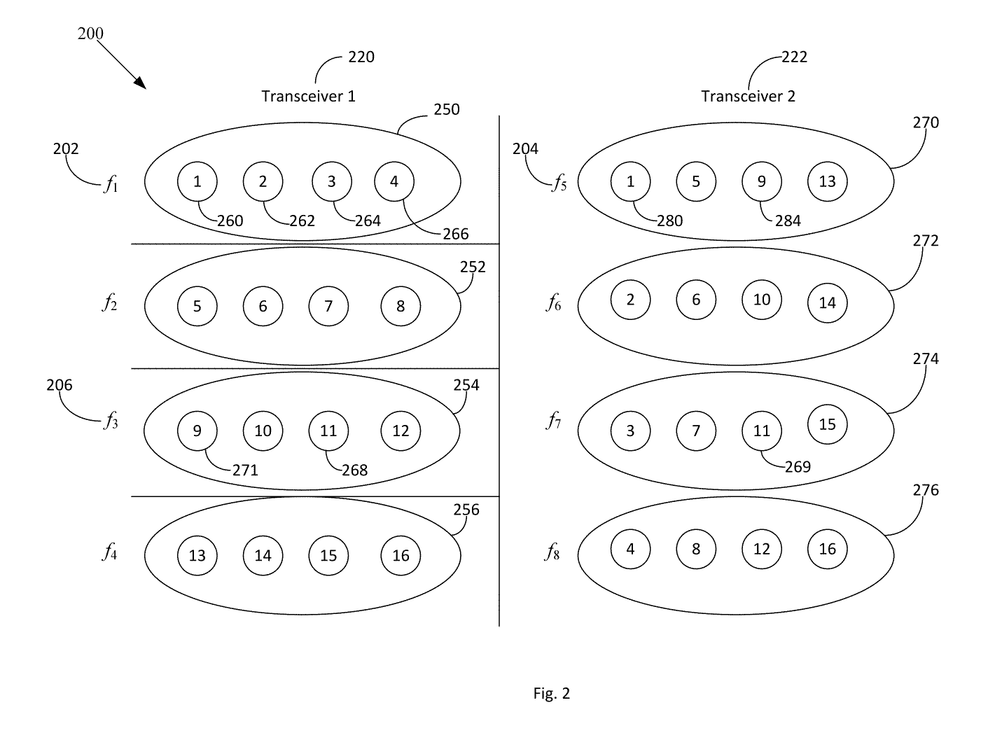

FIG. 2 illustrates a channel assignment 200 for a network of N=16 nodes using channels f₁ to f₈. Nodes in the second transceiver group 222, Tx-2, may be obtained by interleaving nodes from the Tx-1 groups 220. As shown herein below, the same idea can be applied in a hierarchical fashion to obtain assignments for the general T case. Hence, this family of schemes may be referred to as HINT-T: Hierarchical Interleaved Channel Assignment with T transceivers.

Here, T may be equal to 2 and M=N^{1/2}. The first transceivers may be grouped into M groups 250-256, each containing M nodes 260, 262, 264, 266. These may be referred to as the Tx-1 groups 220 and consecutively numbered nodes 260-266 may be assigned to each group. For example, the first transceiver group 220, Tx-1, contains nodes 1, 2, . . . , M, the second transceiver groups 222, Tx-2 contain nodes M+1, M+2, . . . , 2M, etc.

Each of the transceiver groups 220, 222 thus formed is assigned an orthogonal channel. Since there are a total of 2M groups 250-256, 270-276, the total number of channels used is 2M.

The scheduling and routing strategy that is used with this assignment will now be described. For a scheduling strategy, every transceiver 220, 222 in a group 250-256, 270-276, respectively, gets the same fraction of time to transmit on that group's channel. Since each group has M nodes with each having M transceivers, every transceiver in the group gets 1/M of the total transmission capacity of the channel.

For a routing strategy, if a destination node d is in the same Tx-1 group 220, 222, for any source node s, the source node transmits directly to d in one hop on its Tx-1 channel. Else, s transmits to node r in its Tx-2 group which shares its Tx-1 group with d. Node r then forwards to d using its Tx-1 channel.

For example, in FIG. 2, the route from node 1 260 to node 3 264 follows the path 1-3 on channel f₁ 202. This involves transmissions by the first transceiver of node 1. On the other hand, the route from node 1 260/280 to node 11 268, 269 follows the path from node 1 280 to node 9 284 on channel f₅ 204 and from node 9 271 to node 11 268 on channel f₃ 206. This involves transmissions by the second transceiver 222 of node 1 280 and the first transceiver 220 of node 271. It can be seen that this routing strategy ensures that every node is within 2 hops of any other node.

The HINT-2 assignment along with the scheduling and routing strategy as described above may be used to achieve a throughput of 1/M for every node. For N^{1/2}=M (where M is an integer), HINT-2 can achieve a uniform per node throughput of 1/N^{1/2} using 2N^{1/2} channels. Because of the symmetry of the assignment, it is sufficient to focus on the total load on each of the two transceivers 220, 222 of node 1 260, 280 and show that it can be supported. Considering the second transceiver 222 of node 1 280, node 1 280 transmits packets generated by itself that are destined for nodes in Tx-1 groups 250-256 other than its own group. There are M−1 such groups and each group has M nodes. Node 1 260, 280 generates packets at rate

$$\frac{λ}{N - 1}$$

for each of these nodes. Thus, the total traffic load on the second transceiver 222 of node 1 280 is given by

$$\frac{λ M ( M - 1 )}{N - 1} .$$

This may be less than the total transmission rate 1/M. Solving this provides:

$$λ \leq \frac{N - 1}{{M}^{2} ( M - 1 )} = \frac{{M}^{2} - 1}{{M}^{2} ( M - 1 )} = \frac{1}{M} + \frac{1}{{M}^{2}} \qquad ( 1 )$$

From this, it can be seen that λ=1/M satisfies equation 1 above. A similar result may be shown for the first transceiver 220 of node 1 260. Since HINT-2 uses 2M channels and M=N^{1/2}.

For T>2, let M=N^{1/T}. Similar to the T=2 case, the HINT-T strategy forms M^{T-1} groups for every transceiver index. To generalize, the groups corresponding to transceiver index k are called Tx-k groups where 1≦k≦T. Each Tx-k group contains M nodes and is assigned one orthogonal channel. Since there are a total of TM^{T-1} such groups, the total number of channels used under HINT-T is TM^{T-1}. The node assignment to these groups is performed as follows.

Fix a transceiver index k where 1≦k≦T. Let i and j be integers such that 1≦i≦M^{T-k} and 1≦j≦M^{k-1}. Then the Tx-k group number (i−1)M^{k-1}+j contains the following nodes:

{(i−1)M^{k}+j,(i−1)M^{k}+j+M^{k-1},

(i−1)M^{k}+j+2M^{k-1},(i−1)M^{k}+j+3M^{k-1}, . . .

(i−1)M^{k}+j+(M−1)M^{k-1}}. (2)

This definition ensures that every Tx-k group has M nodes. Further, the total number of Tx-k groups is Σᵢ₋₁^{M}^{_{T−k}} Σⱼ₌₁^{M}^{_{k−1}} 1=M^{T-1}.

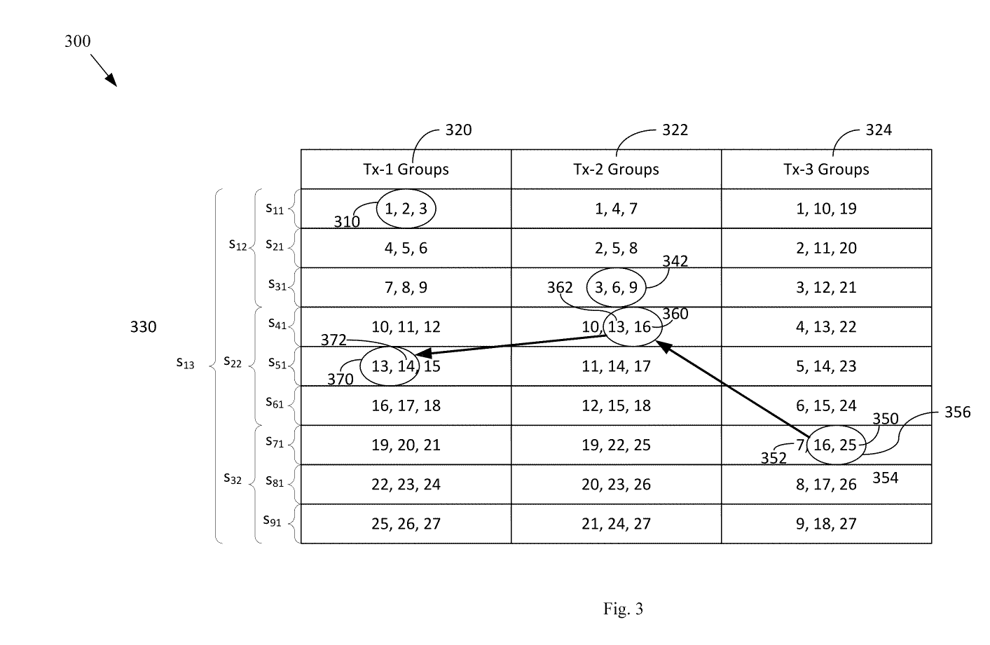

FIG. 3 shows the HINT-3 assignment 300 for a network of N=27 nodes 310 with T=3 transceivers 320, 322, 324 per node. In general, the HINT-T assignment 300 ensures that every node is within T hops of any other node.

In order to describe the routing strategy, the following collection of sets are defined for each transceiver index k where 1≦k≦T. For 1≦i≦M^{T-k}, Sᵢₖ is defined as the set containing the nodes (i−1)M^{k}+1 to iM^{k}. For each k, there are M^{T-k} such sets, each containing M^{k} consecutively numbered nodes. These may be referred to as the “level k sets.” FIG. 3 illustrates these sets for N=27 310. Note that for k=3 320, 322, 324, there is one such set S₁₃ 330 and it includes all nodes.

The following properties follow directly from the definition of the level sets and the HINT-T assignment in equation 2.
Any two level sets Sᵢₖ and Sⱼₖ where i≠j are disjoint.
Any level set Sᵢₖ where k>1 is a union of M level sets from level k−1.
Under the HINT-T assignment from equation 2, for 1≦k≦T−1, no two nodes from any Sᵢₖ are in the same Tx-k+1 group.

To illustrate the third property in FIG. 3, note that nodes 1-3 310 from the first Tx-1 group 320 are in different Tx-2 groups 322, i.e., s₁₁ s₂₁, s₃₁. Similarly, nodes 3, 6, 9 342 from the third Tx-2 group 322 are in different Tx-3 groups s₃₁, s₇₁, s₉₁. This is precisely the interleaving of nodes from lower Tx groups to form upper Tx groups as seen in HINT-2. HINT-T generalizes this interleaving to T hierarchical levels.

Next, the scheduling and routing strategy that is used with HINT-T is described. For a scheduling strategy, every transceiver in a group gets 1/M of the total transmission capacity of the channel, which is similar to HINT-2 strategy. For a routing strategy, k(a, b) is defined, for any two nodes a and b, as the smallest k for which there exists a level set Sᵢₖ such that both a and b are in Sᵢₖ. Note that at least one such set exists since the set S_{1T} contains all nodes. Further, k(a, b)≦T for all a, b. The routing strategy from a source node s to a destination node d can be described using these k(a, b) values.

First, k(s, d) is calculated. If k(s, d)=1, then d is in the same Tx-1 group as s, and s transmits directly to d in one hop using its first transceiver. If k(s, d)≠1, then d is in a different Tx-1 group than s. If d is in the same Tx-k (s, d) group as s, then s transmits directly to d in one hop using its k(s, d)^{th} transceiver.

Else, S determines the node with the smallest value of k(r, d) among its neighbors r in its Tx-k(s, d) group. This node is denoted by r*. Then s relays the packet to node r* using its k(s, d)^{th} transceiver. Node r* now uses the same algorithm as described before to route the packet to d.

Accordingly, in FIG. 3, where node 25 wants to send to node 14. A calculation of k(25, 14) is performed. Using FIG. 3, it can be seen that S₁₃ 330 is the only set that has both nodes 25 and 14. Thus, we have that k(25, 14)=3. Next, since 14 is not a neighbor of node 25 350 in node 25's Tx-3 group 356, node 25 calculates k(7,14) and k(16, 14) for its Tx-3 group 324 neighbors 7 352 and 16 354. Using FIG. 3, k(7, 14)=3 and k(16, 14)=2. Therefore, node 25 350 forwards the packet to node 16 354 for relaying to the destination. This procedure is now repeated by node 16 354, where node 16 360 uses the second transceiver 322 to transmit to node 13 362 in its Tx-2 group 322. From there, node 13 370 uses its first transceiver in transmitter group 320 to transmit to node 14 372 in its Tx-1 group 320.

The HINT-T routing strategy ensures that there are at most T hops between any pair of nodes. Given any set Sᵢₖ, a node a ε Sik may reach any other node b ε Sᵢₖ in at most k hops using the HINT-T routing strategy and the level set S_{1T} contains all nodes.

The HINT-T assignment along with the scheduling and routing strategy as described above may achieve a throughput of 1/M for every node. For N^{1/T}=M (where M is an integer), HINT-T achieves a uniform per node throughput of 1/N^{1/T} using TN_{T}^{T-1} channels. This implies that, if T=log₂ N and if there are N log₂ N/2 channels available, then HINT-T can achieve a per node throughput given by 1/N^{1/log}^{₂}. Thus, it is possible to get Θ(1) per node throughput if each node has log₂ N transceivers and there are N log₂ N/2 channels available. This is in sharp contrast to the case of a single radio network, i.e., T=1. Note that the best possible uniform throughput for T=1 under static channel assignment is 1/N. This is because when T=1, transceivers may share the same channel so that the network remains connected. However, when T>1, much higher throughput can be achieved. This shows that there is a fundamental difference between single radio and multi radio networks when static channel assignment is used.

However, requiring Θ(log₂ N) transceivers per node may be impractical. The availability of Θ(N log₂ N/2) channels may also be impractical.

This raises the question of whether the number of transceivers per node and total channels to be used to grow to infinity to get θ(1) per node throughput. Further, there is a question of whether there a fundamental way to characterize the performance of any channel assignment strategy. Specifically, the relationship between number of transceivers, number of channels used, network size and per node throughput are to be determined.

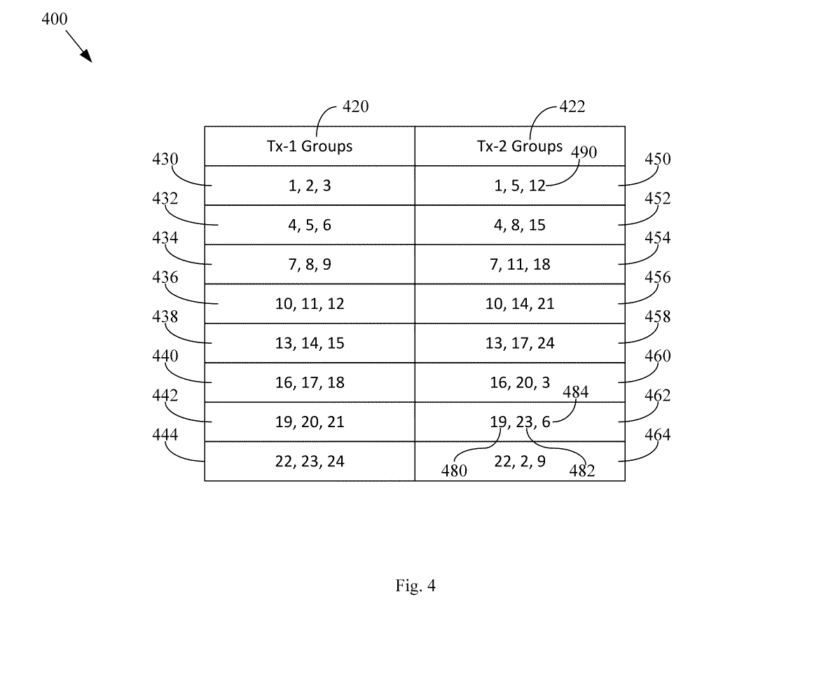

FIG. 4 shows channel assignments 400 for a network of N−24−8 log₂8 nodes with T=2 according to an embodiment.

According to another embodiment,

$$Θ ( \frac{1}{{( {log}_{2} N )}^{2}} )$$

throughput per node may be achieved with two transceivers per node using

$$θ ( \frac{N}{{log}_{2} N} )$$

channels using a LOG-2 process. The main idea behind this process is to first form two sets of groups, one per transceiver index 420, 422. Each set contains

$$θ ( \frac{N}{{log}_{2} N} )$$

groups 430-444, wherein each group has size θ(log₂ N) nodes. Then, the strategy assigns nodes to these groups in such a way that a node can reach any other node in at most θ(log₂ N) hops. For simplicity of presentation, N is of the form N=M log₂ M where log₂M εZ⁺. However, this process may be modified to be applicable when this is not the case.

The channel assignment is performed by first grouping the first transceiver of all nodes into M Tx-1 groups 430-444, wherein each contains log₂ M consecutively numbered nodes. Thus, the k^{th} Tx-1 group contains nodes (k−1) log₂ M+1, (k−1) log₂ M+2, . . . , k log₂ M.

Next, the second transceiver of all nodes is grouped into M Tx-2 groups 450-464, each containing log₂ M nodes. Nodes are assigned as follows. For 1≦i≦log₂ M, the i^{th} node from Tx-1 group number ((j−1+2ⁱ⁻¹) mod M) is assigned to be the i^{th} node of Tx-2 group number j (where 1≦j≦M). The “mod M” operation used here and in rest of the paper is defined, for any non-negative integers a and b, using use the following definition:

$$( a mod M ) {=}^{Δ} \{ \begin{matrix}M & if a = bM \\ x if a = bM + x & where 0 < x < M\end{matrix} .$$

Each of the groups thus formed is assigned an orthogonal channel. Since there are a total of 2M groups, the total number of channels used is 2M.

To illustrate the working of the algorithm, consider Tx-2 group number 7 462. For 1≦i≦3, the i^{th} node from Tx-1 group number ((7−1+2ⁱ⁻¹)mod 8) is assigned to be the node of this group. For i=1, this is given by the first node of Tx-1 group (6+1 mod 8)=7, i.e., node 19 480. For i=2, this is given by the second node of Tx-1 group (6+2 mod 8)=8, i.e., node 23 482. For i=3, this is given by the third node of Tx-1 group (6+4 mod 8)=2, i.e., node 6 484.

In any Tx-2 group number j, there is one node from each of the Tx-1 groups numbered ((j−1+2i−1) mod M) where 1≦i≦log2 M. This means that the difference between the Tx-1 group numbers of consecutive nodes in a Tx-2 group follows the geometric sequence 2⁰, 2¹, 2², . . . 2ⁱ⁻¹ where 1≦i<log₂ M.

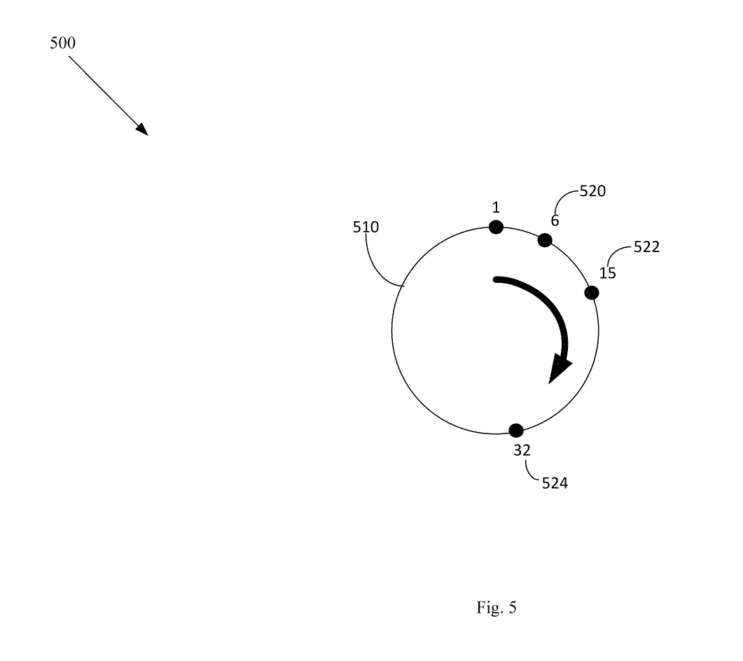

FIG. 5 illustrates the formation of Tx-2 groups under logarithmic with two transceivers (LOG-2) 500 according to an embodiment. Nodes in the first Tx-2 group under LOG-2 assignment for N=64 are placed on a ring 510. It can be seen that the neighboring nodes of node 1, i.e., node 6 520, node 15 522 and node 32 524, are located progressively farther away as traversing clockwise on the ring 510. The assignment on Tx-1 ensures that node 1 510 may reach close by nodes 2, 3, 4 (not shown) in one hop. Using a combination of local neighbors on Tx-1 and progressively farther away neighbors on Tx-2, a node is within 2 log₂ M+1 hops of any other node, much like the use of distributed hash tables for fast lookups.

A routing strategy according to an embodiment is based on the following collection of sets for each Tx-2 group j (where 1≦j≦M). For every i^{th} node in this group. A set u_{i,j} is defined as follows. For 1≦i≦log₂ M−1, u_{i,j} contains 2ⁱ⁻¹ Tx-1 group numbers, starting from ((j−1+2ⁱ⁻¹) mod M and incrementing by 1 and using the “mod M” operation as defined earlier. For i=log₂ M, u_{i,j} contains (2ⁱ⁻1+1) Tx-1 group numbers, starting from ((j−1+2ⁱ⁻¹) mod M) and incrementing by 1 while using the mod M operation. For example, for the network in FIG. 4:

u₁₁={1},u₂₁={2,3},u₃₁={4,5,6,7,8}

u₁₇={7},u₂₇={8,1},u₃₇={2,3,4,5,6}

There are a total of M log₂ M such sets. These sets are used for the following routing strategy.

A node at the i^{th} level of Tx-2 group j is responsible for relaying to nodes in those Tx-1 groups whose index is in the set u_{i,j}. Thus, this set lists those Tx-1 groups that are “covered” by this node. Hence, it is called a Cover Set. For example, in FIG. 4, node 5 490 which is at the 2^{nd} level in Tx-2 group 1 450 forwards data for destinations in the set of Tx-1 groups in u₂₁. Likewise, node 6 484, which is at the 3^{rd} level in Tx-2 group 7462 forwards data for destinations in the Tx-1 groups of u₃₇. For any 3, the sets u_{i,j} are disjoint and their union covers Tx-1 groups 420.

The scheduling strategy under LOG-2 provides every transceiver in a Tx-1 group 420 the same fraction of time to transmit on that group's channel. However, the first node gets the transmission time in a Tx-2 group 422. However, the routing strategy of LOG-2 may use the first node of each Tx-2 group 422 to transmit on that group's channel.

The routing strategy under LOG-2 involves a node n that has a packet destined for node m. This packet could have been generated by node n itself, or it could have been forwarded to n to be relayed to m. If the Tx-1 group number of nodes n and m be g(n) and g(m) respectively, then to route a packet from n to m, n first checks if m is in its Tx-1 group, i.e., if g(n)=g(m). If yes, then n transmits directly to m in one hop using its first transceiver. Else, n transmits the packet to the first node in Tx-1 group number g(n) for relaying to n. This step is not used if n itself is the first node in its Tx-1 group.

Let q be the first node in Tx-1 group g(n). Under LOG-2, q will also be the first node in Tx-2 group g(n). Node q checks if m is in its Tx-2 group. If yes, it transmits directly to m in one hop using its second transceiver. Else, node q transmits the packet to that node in its Tx-2 group that “covers” node m. More precisely, q transmits to the i^{th} node in its Tx-2 group for forwarding to m where 2≦i≦log₂ M and g(m) εu_{i,g(n)}This process is repeated until the packet gets delivered.

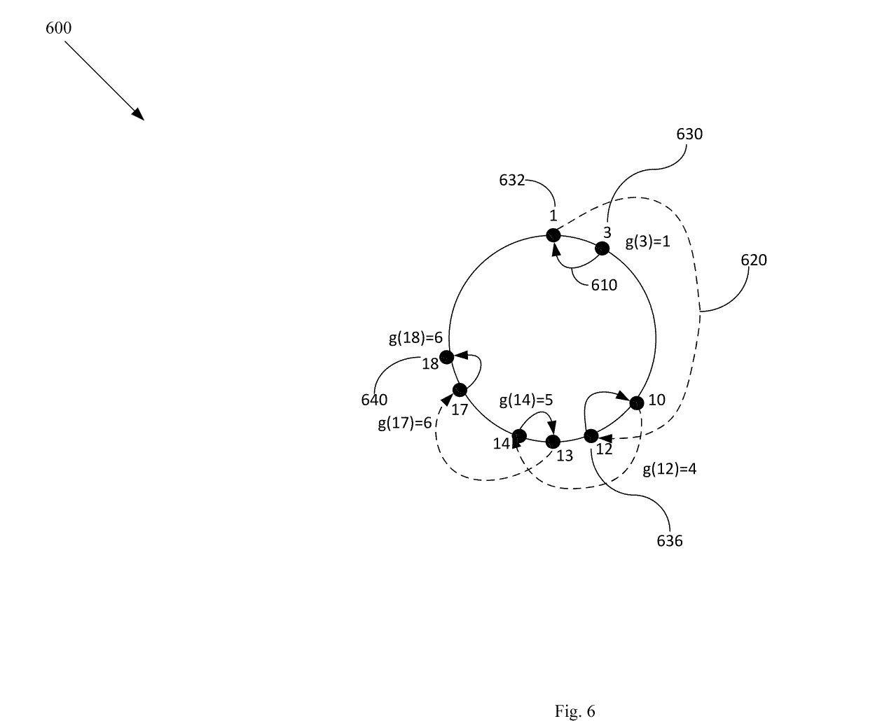

FIG. 6 illustrates the routing strategy under LOG-2 600 according to an embodiment. In FIG. 6, solid arrows 610 show transmissions in Tx-1 groups and dashed arrows 620 show transmissions in Tx-2 groups. FIG. 6 illustrates this procedure for the 24 node network 400 of FIG. 4. In FIG. 6, when node 3 630 wants to send to node 18 640, g(3)=1 to node 1 632 and g(18)=6 for node 18 640. Thus, node 3 630 transmits the packet to node 1 632 in its Tx-1 group for relaying to node 18 640. Node 1 632 checks if node 18 640 is in its Tx-2 group. Since node 18 640 is not in its Tx-2 group, node 1 632 determines the node in its Tx-2 group that covers node 18 640. This node is given by the third node, i.e., node 12 636, since u₃₁={4, 5, 6, 7, 8}. Therefore, node 1 632 transmits the packet to node 12 636 in its Tx-2 group. Node 12 636 now repeats this procedure. FIG. 6 shows the final outcome of this process, wherein the route is given by 3-1-12-10-14-13-17-18. The hops alternate between Tx-1 and Tx-2 group transmissions. Further, the first node of a Tx-2 group transmits in any Tx-2 group transmission.

The LOG-2 routing strategy ensures that there are at most 2 log₂ N+1 hops between any pair of nodes. This is based on the observation that, at each step in a Tx-2 transmission, the distance between the node holding the packet and the destination decreases by at least half.

The LOG-2 assignment along with the scheduling and routing strategy, as described above, may be used to achieve a throughput of 1/log₂ M)² for every node. For N=Mlog₂ M, where log 2 M εZ+, LOG-2 can achieve a uniform per node throughput of 1/(log₂ M)2 using 2M channels. Because of the symmetry of the assignment, it is sufficient to focus on the total load on the nodes in the first Tx-1 group and the first Tx-2 group. Then, a bound on the total number of group-to-group traffic flows that involve these groups may be calculated. This is used to show that a per node input rate of 1/(log₂M)2 is feasible.

LOG-2 may thus achieve a per node throughput of at least 1/(log₂(N))² with two transceivers per node. Therefore, a throughput close to Θ(1) per node may be obtained with Θ(1) transceivers per node. However, under the parking lot model, Ω(N) channels are used to get Θ(1) per node throughput irrespective of the number of transceivers per node. However, given Ω(N) channels, achieving a throughput of Θ(1) per node throughput using Θ(1) transceivers per node under static channel assignment may not be possible.

π is used to denote the set of possible feasible policies for channel assignment, routing, and scheduling under the network model. A simple relation exists between the total number of channels used, network size, and maximum per node throughput achievable under any policy p εP. Cₚ is used to denote the number of channels used by the channel assignment under p and L̅ₚ is used to denote the resulting average path length traversed by a packet under p. An average is taken over source-destination pairs. The maximum per node input rate that can be supported under p is λₚ. Then, since the total traffic load cannot exceed the total transmission capacity of the network:

NλₚLₚ≦Cₚ. (3)

The left hand side of equation (3) denotes the time average total number of transmissions to deliver packets from sources to destinations. This cannot exceed Cₚ, i.e., the maximum number of transmissions possible per unit time. Since L̅ₚ≧1 under any p, it follows from equation (3) that Cₚ=λ(N) when λ=Θ(1). Equation (3) is a condition for the feasibility of any input rate and can be used to establish a lower bound on the performance of any policy.

Then the efficiency of p, ηₚ for any channel assignment, routing, and scheduling policy p επ that uses Cₚ channels in a parking lot network of size N, a maximum per node input rate of λₚ may be supported. Then the efficiency of p, ηₚ is defined as:

$${η}_{p} {=}^{Δ} \frac{N {λ}_{p}}{{C}_{p}} . \qquad ( 4 )$$

Since L̅ₚ≦1 under any p, using equation (3) it follows that ηₚ≦1 for all p εP. This includes the throughput maximizing policy obtained by solving the optimization problem for the tuple (N, T, Cₚ) Therefore, the maximum per node throughput achievable under a given policy p that uses Cₚ channels in a network of size N is within a factor ηₚ of the maximum per node throughput achievable under any policy that uses Cₚ channels on the same network. Thus, the efficiency of a policy establishes a lower bound on its performance.

Using the above results, the efficiency of the HINT-T and LOG-2 strategies can be calculated. Since HINT-T uses

$${TN}^{\frac{T - 1}{T}}$$

channels to support per node rate of

$$1 / {N}^{\frac{1}{T}} ,$$

η_{pHINT-T} is:

$${η}_{HINT \text{-} T} = \frac{N}{{N}^{1 / T} \times {TN}^{\frac{T - 1}{T}}} = \frac{1}{T} . \qquad ( 5 )$$

For a fixed T, η_{HINT-T} is independent of the network size N. Thus, HINT-T is within a constant factor of the optimal solution. Likewise, for N=M log₂ M, LOG-2 uses 2M channels to support per node rate of 1/(log₂ M)², which yields:

$${η}_{LOG \text{-} 2} = \frac{N}{{( {log}_{2} M )}^{2} 2 M} = \frac{1}{2 {log}_{2} M} > \frac{1}{2 {log}_{2} N} \qquad ( 6 )$$

Thus, the LOG-2 scheme is within a logarithmic (in network size) factor of the optimal solution. This may suggest that HINT-T has a better performance than LOG-2. However, for any given T, the maximum per node throughput under HINT-T is 1/N^{1/T}, while LOG-2 can achieve at least 1/(log₂ N)² with T=², which exceeds 1/N^{1/T} for sufficiently large N.

Simulation-based results for a parking lot network with 4 transceivers per node compares

HINT-T and LOG-2 performance against two representative schemes referred to as RING and GRID.

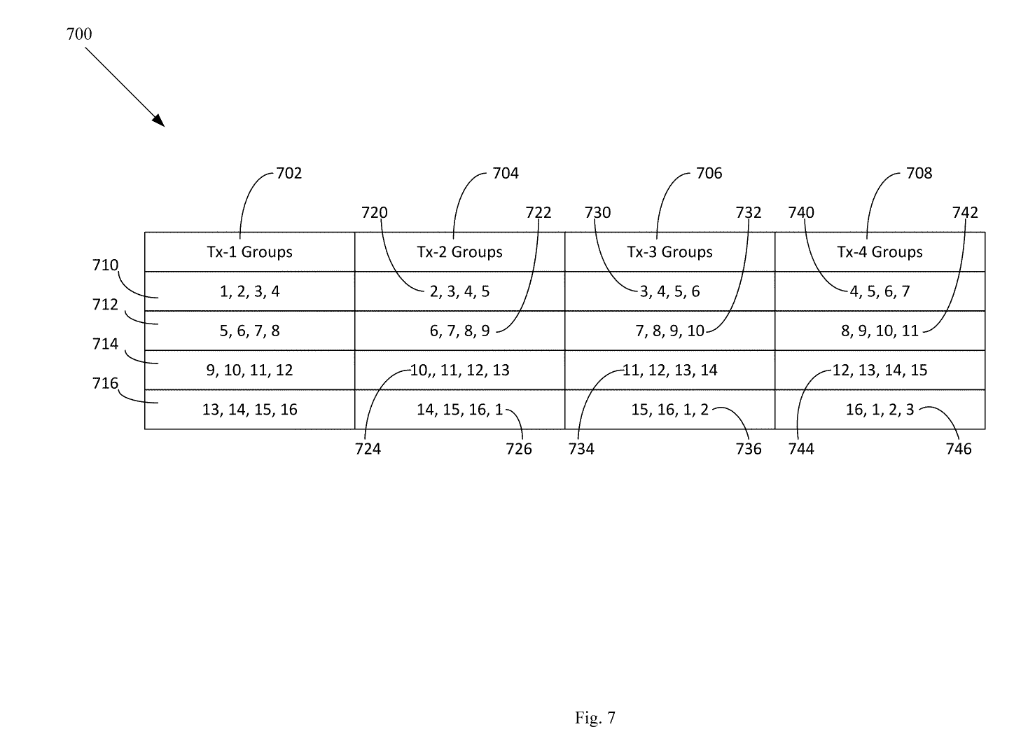

FIG. 7 illustrates a channel assignment 700 under RING for N=16. The RING assignment scheme first forms N/4 Tx-1 groups 710-716 for Tx-1 702, each of size 4 and containing consecutively numbered nodes. The transceiver groups 720-726, 730-736, 740-746 for Tx-2 704, Tx-3 706 and Tx-4 708, respectively, are obtained by shifting node IDs of each Tx-1 group 710-716 by 2, 3 and 4 with wraparound. The resulting topology resembles a ring (similar to Example 1 in FIG. 1), hence the name. A GRID scheme places nodes in a 2-dimensional degree 4 torus grid and assigns a channel to each link in the resulting graph. Thus, each Tx group contains 2 nodes.

Under the RING assignment, it is easy to show that the average path length over source-destination pairs is Θ(N). Similarly, the total number of channels used is N=Θ(N). Thus, using equation (3), it follows that the maximum per node throughput under RING is Θ(1/N) and its efficiency is η_{RING}=Θ(1/N). Under the GRID assignment, the average path length over source-destination pairs can be shown to be Θ(\sqrt{N}) while the total number of channels used is 2N=Θ(N). Thus, using equation (3), it follows that the maximum per node throughput under GRID is Θ(1/\sqrt{N}). Further, using equation (4), its efficiency is η_{GRiD}=Θ(1/\sqrt{N}).

For the simulation, the input topology is a parking lot MC-MR network of size N nodes, where V is varied between 16 and 100. These nodes are placed in a 250 m×250 m in area and use a fixed transmit power such that nodes are within the transmission range of each other. Every node has 4 identical transceivers, each capable of operating on a channel of bandwidth 10 MHz assuming that such channels are available starting from 900 MHz. Each transceiver independently uses 802.11 CSMA for medium access on its assigned frequency channel. The raw MAC level throughput per channel is 1.2 Mbps.

Under each scheme, the assignments to the different transceivers are determined at the start of a simulation run and fixed for the duration of that run. In each run, traffic is generated using the uniform all-pair unicast model. Specifically, every node generates packets according to a Poisson process of fixed rate and each packet is equally likely to be destined to any of the other nodes. Packets are assumed to be fixed size user datagram protocol (UDP) packets of length 436 bytes that include control headers. Each simulation run has a duration of 150 seconds, wherein the total number of packets delivered successfully to their destinations is then counted. Default link state routing protocol available in optical networks for routing packets is used. Load balanced routing strategies under HINT and LOG, as discussed earlier, are not implemented. Thus, the achievable performance of HINT and LOG with load balanced routing is expected to outperform the results of the simulation.

The maximum achievable per node throughput under each scheme are to be compared. In addition, the results from the simulation may be compared against the theoretical bounds. Given a network size and an assignment scheme X, simulations were run with increasing values of the input rate until the total number of delivered packets does not increase anymore. This is referred to as the “saturation throughput” under X for a given N and it is used as a measure of the maximum per node achievable throughput under X for N. The theoretical bounds for maximum throughput are derived under idealized assumptions, such as collision free transmission scheduling, load balanced routing, no buffer overflows, and ignoring any control overheads (such as due to CSMA and link state routing updates). This no longer holds in the simulations, which are closer to the realistic setting. However, these factors affect the schemes being compared and the saturation throughput can be thought of as a measure of the remaining effective capacity.

Table 1 summarizes the theoretical performance bounds for RING, GRID, 2×HINT-2, 2×LOG-2, and HINT-4. The 2×HINT-2 process implements HINT-2 on transceivers 1, 2 and repeats it on transceivers 3, 4. Similarly, the 2×LOG-2 process implements LOG-2 on transceivers 1, 2 and repeats it on transceivers 3,4.

TABLE 1

| | Process | | |
|---|---|---|---|
| | λₚ | Cₚ | ${η}_{p} = \frac{N {λ}_{p}}{{C}_{p}}$ |
| RING | $Θ ( \frac{1}{N} )$ | Θ(N) | $Θ ( \frac{1}{N} )$ |
| GRID | $Θ ( \frac{1}{\sqrt{N}} )$ | Θ(N) | $Θ ( \frac{1}{\sqrt{N}} )$ |
| 2 × HINT-2 | $Θ ( \frac{1}{\sqrt{N}} )$ | Θ(\sqrt{N}) | Θ(1) |
| 2 × LOG-2 | $Θ ( \frac{1}{{( {log}_{2} N )}^{2}} )$ | $Θ ( \frac{N}{{log}_{2} N} )$ | $Θ ( \frac{1}{{log}_{2} N} )$ |
| HINT-4 | $Θ ( \frac{1}{{N}^{1 / 4}} )$ | Θ(N^{3/4}) | Θ(1) |

The different processes are first compared in terms of their saturation throughput.

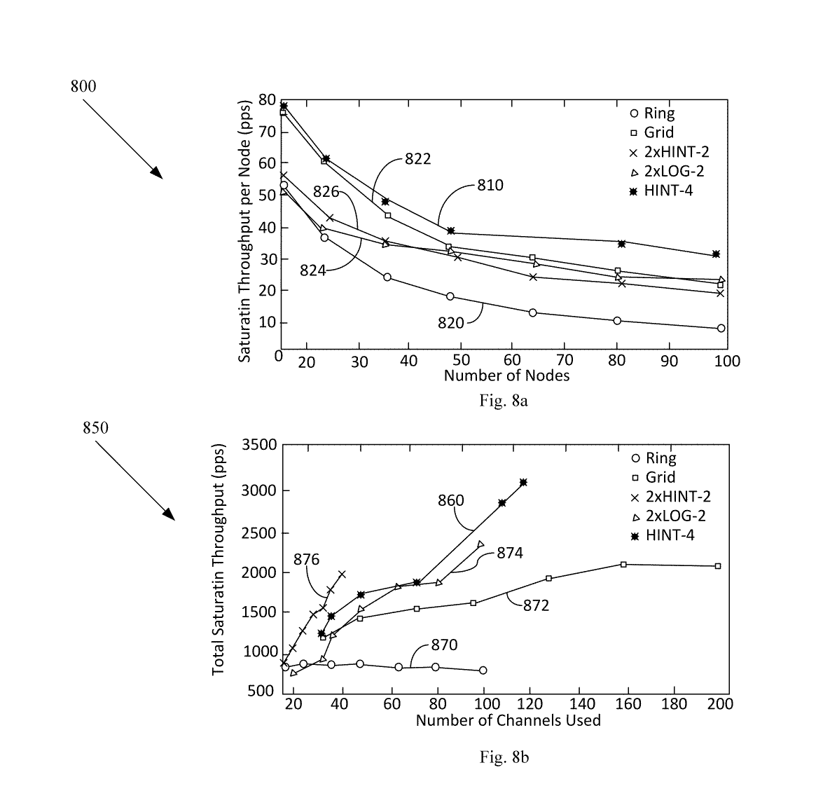

FIG. 8a illustrates the plots the per node saturation throughput (in packets/sec, pps) vs. N 800 according to an embodiment. As can be seen, HINT-4 810 outperforms the RING scheme 820 by 200-300% for high tens of nodes, and outperforms its nearest rival GRID 822 by nearly 150% at N=100. The behavior of the curves is consistent with the theoretical bounds with RING 820 showing the largest drop as N increases. The per node throughput under 2×LOG-2 824 scales as Θ(1/(log₂ N)²) which is the best scaling performance among these schemes. However, in the finite range of N considered here, HINT-4 810 outperforms 2×LOG-2 824. Both GRID 822 and 2×HINT-2 826 also outperform 2×LOG-2 824 up to a crossover point, after which 2×LOG-2 824 is better. Eventually, 2×LOG-2 824 will outperform HINT-4 810 as well after a sufficiently large N.

GRID 822 generally has a better performance than both 2×HINT-2 826 and 2×LOG-2 824. However, this plot considers the per node saturation throughput and does not capture the total number of channels used. To incorporate this, the processes are next compared in terms of their efficiency.

FIG. 8b illustrates the plots of the total network saturation throughput vs. the number of channels used under each process 850 according to an embodiment. Recall that efficiency of a process is the ratio between maximum total network throughput and the total number of channels used. Thus, the slope of the performance curve for a process in FIG. 8b may be interpreted as its efficiency at that point. It can be seen that both 2×HINT-2 876 and 2×LOG-2 874 have much higher efficiency than GRID 872. Further, this gap increases with N.

FIG. 8b also agrees quite well with the theoretical bounds. The 2×HINT-2 876 and HINT-4 860 processes both have a theoretical efficiency of Θ(1), i.e., independent of N (see Table 1). Their curves in FIG. 8b have a slope that does not decrease with N. On the other hand, RING 870 has an efficiency of Θ(1/N which goes to 0 as N increases. Its curve in FIG. 8b flattens to slope 0 quickly. GRID 872 has efficiency Θ(1/\sqrt{N}). Its curve also flattens, but more slowly than RING. Finally, 2×LOG-2 874 has efficiency Θ(1/log₂ N) and its slope is even slower to flatten.

In terms of both per node throughput and efficiency, RING 870 has the worst performance. Intuitively, this is because under RING 870, packets may traverse Θ(N) hops on average, resulting in a vast majority of traffic being relay traffic. GRID 872 improves upon RING 870 because the average distance between nodes is nowΘ(\sqrt{N}). It has similar scaling as HINT-2 876 in terms of throughput but uses a lot more channels. Thus, it has poor efficiency. The HINT-T schemes have the best performance in terms of their efficiency, which does not depend on N. However, in terms of throughput, T may be large to remain close to Θ(1) as N increases. LOG-2 874 may achieve this with just 2 transceivers. However, its efficiency is not as good as HINT-T. Thus, both HINT and LOG are order optimal or close to order optimal along one of the dimensions (throughput or efficiency).

Scaling laws imply that in a random ad hoc network, if individual transceivers may operate over channels of fixed bandwidth (that does not increase with N), then the best possible scaling is θ(\sqrt{N}) even if the network has a large number of channels available and each node has multiple (but finite) transceivers. Previous strategies have suggested keeping the transmit power sufficiently low, just enough to ensure connectivity, and then using multi-hop routing. The motivation behind reducing the transmit power is to maximize spatial reuse of the finite network bandwidth.

In contrast, according to embodiments described herein, the parking lot model provides significantly higher throughput when nodes have multiple transceivers and the number of available channels scales with the network size. Further, reducing power to maximize spatial reuse of frequency does not help. Rather, it is better to preserve the parking lot structure and use the available channels while keeping inter-node distance small in the resulting effective topology by careful channel assignment.

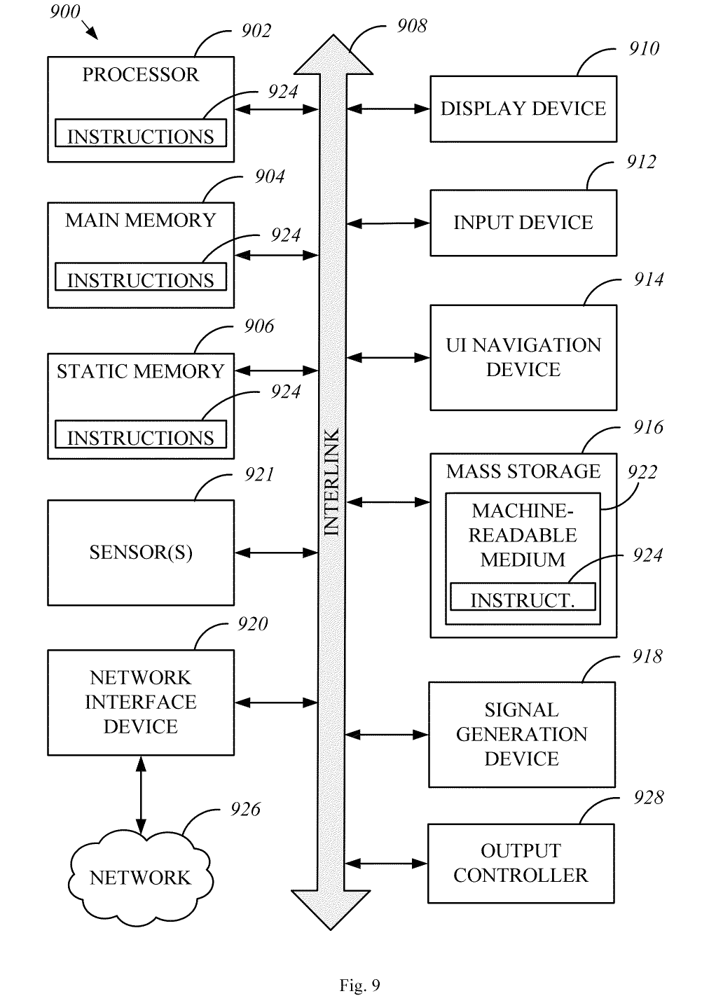

FIG. 9 illustrates a block diagram of an example machine 900 for providing efficient wideband inverse channelization for direct digital synthesizer based jamming techniques according to an embodiment upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine and/or a client machine in server-client network environments. In an example, the machine 900 may act as a peer machine in peer-to-peer (P2P) (or other distributed) network environment. The machine 900 may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, at least a part of one or more computer systems (e.g., a standalone, client or server computer system) or one or more hardware processors 902 may be configured by firmware or software (e.g., instructions, an application portion, or an application) as a module that operates to perform specified operations. In an example, the software may reside on at least one machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor 902 configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

Machine (e.g., computer system) 900 may include a hardware processor 902 (e.g., a central processing unit (CPU), a graphics processing unit (GPU), a hardware processor core, or any combination thereof), a main memory 904 and a static memory 906, at least some of which may communicate with others via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 916, a signal generation device 918 (e.g., a speaker), a network interface device 920, and one or more sensors 921, such as a global positioning system (GPS) sensor, compass, accelerometer, or other sensor. The machine 900 may include an output controller 928, such as a serial (e.g., universal serial bus (USB), parallel, or other wired or wireless (e.g., infrared (IR)) connection to communicate or control one or more peripheral devices (e.g., a printer, card reader, etc.).

The storage device 916 may include at least one machine readable medium 922 on which is stored one or more sets of data structures or instructions 924 (e.g., software) embodying or utilized by any one or more of the techniques or functions described herein. The instructions 924 may also reside, at least partially, additional machine readable memories such as main memory 904, static memory 906, or within the hardware processor 902 during execution thereof by the machine 900. In an example, one or any combination of the hardware processor 902, the main memory 904, the static memory 906, or the storage device 916 may constitute machine readable media.

While the machine readable medium 922 is illustrated as a single medium, the term “machine readable medium” may include a single medium or multiple media (e.g., a centralized or distributed database, and/or associated caches and servers) that configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and compact disk-read only memory (CD-ROM) and digital video disk-read only memory (DVD-ROM) disks.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1x* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

For example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A network, comprising:
N nodes in the network, each of the N nodes comprising T transceivers;
T transceiver node groups, each of the T transceiver node groups comprising a first number of groups of nodes (N^{1-1/T}, N/log₂ N), wherein the first number of groups of nodes for a first of the T transceiver node groups having the N nodes assigned consecutively with a second number of nodes per each of the groups of nodes being a function of N (N^{1/T}, log₂ N), wherein the first number of group of nodes for a remaining number of the transceiver node groups comprises N nodes with transceivers arranged to provide access to any node within a predetermined number of hops (N^{1/T}, log₂ N);
wherein an arrangement of the second number of nodes per each of the groups of nodes in the T transceiver node groups provides an optimized throughput per node.

2. The network of claim 1, wherein the first number of group of nodes is N^{1-1/T}.

3. The network of claim 1, wherein the first number of group of nodes is N/log₂ N.

4. The network of claim 1, wherein the function of N for the second number of nodes per each of the groups of nodes is N^{1/T}.

5. The network of claim 1, wherein the function of N for the second number of nodes per each of the groups of nodes is log₂ N.

6. The network of claim 1, wherein the optimized throughput per node is given by
$$θ ( \frac{1}{{N}^{1 / T}} ) .$$

7. The network of claim 1, wherein the optimized throughput per node is given by
$$Θ ( \frac{1}{{( {log}_{2} N )}^{2}} ) .$$

8. The network of claim 1, wherein T is equal to 2, and the first transceiver node groups is grouped into N^{1-1/T} channels, each channel comprising containing N^{1/T} nodes, consecutively numbered nodes being assigned to each channel, and wherein a second transceiver of all nodes is grouped into N^{1-1/T} channels, each channel comprising containing N^{1/T} nodes, the N^{1-1/T} channels for the first transceiver node group including a first transceiver of the N nodes of each channel and the N^{1-1/T} channels for the second transceiver node group including a second transceiver of the N nodes of each channel.

9. The network of claim 8, wherein the first and second transceivers for the N nodes are arranged to use orthogonal frequencies.

10. The network of claim 1, wherein the arrangement of the second number of nodes per each of the groups of nodes in the T transceiver node groups comprises a network model based on a channel model, a traffic model and a channel assignment model, and a scaling behavior of the throughput is characterized as a function of the N nodes.

11. The network of claim 10, wherein the channel model include a wireless network of N nodes, where all nodes are within a transmission range of each other.

12. The network of claim 10, wherein the traffic model comprises an N source-destination pair random unicast model, wherein every node is a source of one unicast session destined to another node of the N nodes chosen uniformly at random.

13. The network of claim 10, wherein the channel assignment model comprises a static channel assignment where a particular assignment, once assigned, is used for a predetermined period of time.

14. The network of claim 1, wherein a scheduling strategy is used for setting transmission times for each of the transceivers in the T transceiver node groups, the scheduling strategy providing a same fraction of time to transmit on a channel associated with the group.

15. The network of claim 1, wherein a routing strategy is used for controlling transmission form a source node, s, to a destination node, d, wherein the routing strategy comprises the source node, s, transmitting directly to the destination node, d, in one hop on a channel associated with the source node when the destination node is in the group of the source node.

16. The network of claim 1, wherein a routing strategy is used for controlling transmission form a source node, s, to a destination node, d, wherein the routing strategy comprises a source node, s, transmitting directly to a related node, r, disposed in a group of the source node and sharing a group of the destination node.

17. The network of claim 1, wherein a node generates packets at a rate
$$\frac{λ}{N - 1}$$
packets per second, and wherein a total traffic load on a second transceiver of a node is given by
$$\frac{λ M ( M - 1 )}{N - 1} .$$

18. A method for providing channel assignment processes for high density multi-channel multi-radio (MC-MR) networks wireless networks, comprising:
providing N nodes in a network, each of the N nodes comprising T transceivers;
providing T transceiver node groups, each of the T transceiver node groups comprising a first number of groups of nodes;
assigning the N nodes consecutively for the first number of groups of nodes for a first of the T transceiver node groups having the N nodes;
arranging a second number of nodes per each of the groups of nodes as a function of N; providing the first number of group of nodes for a remaining number of a transceiver node groups of N nodes with transceivers arranged to provide access to any node within a predetermined number of hops; and
using an arrangement of the second number of nodes per each of the groups of nodes in the T transceiver node groups to provide an optimized throughput per node.

19. The method of claim 18, wherein the providing the first number of group of nodes comprises providing N^{1-1/T} group of nodes.

20. The method of claim 18, wherein the providing the first number of group of nodes comprises providing N/log₂ N group of nodes.

21. The method of claim 18, wherein the arranging a second number of nodes per each of the groups of nodes as a function of N comprises arranging a second number of nodes per each of the groups of nodes as a function of N^{1/T}.

22. The method of claim 18, wherein the arranging a second number of nodes per each of the groups of nodes as a function of N comprises arranging a second number of nodes per each of the groups of nodes as a function of log₂ N.

23. The method of claim 18, wherein the using an arrangement of the second number of nodes per each of the groups of nodes in the T transceiver node groups to provide an optimized throughput per node of
$$θ ( \frac{1}{{N}^{1 / T}} ) .$$

24. The method of claim 18, wherein the using an arrangement of the second number of nodes per each of the groups of nodes in the T transceiver node groups to provide an optimized throughput per node of
$$Θ ( \frac{1}{{( {log}_{2} N )}^{2}} ) .$$
